(19) United States
(12) Patent Application Publication
(10) Pub. No.: US 2024/0218151 A1
(43) Pub. Date: Jul. 4, 2024

(54) HALOGEN FREE FLAME RETARDANT THERMOPLASTIC ELASTOMER

(71) Applicant: Avient Corporation, Avon Lake, OH (US)

(72) Inventors: Zachary ZANDER, Lake Geneva, WI (US); Bret CHISHOLM, North Canton, OH (US); Maryline DESSEIX, Bouge (BE); Thomas SCHLEGEL, Kaltenhouse (FR)

(73) Assignee: Avient Corporation, Avon Lake, OH (US)

(21) Appl. No.: 17/769,014

(22) PCT Filed: Oct. 14, 2020
(86) PCT No.: PCT/US2020/055564

§ 371 Date: Apr. 14, 2022

Related U.S. Application Data
(60) Provisional application No. 62/915,167, filed on Oct. 15, 2019.

(51) Int. Cl. C08K 3/32; C08L 91/00

(52) U.S. Cl. CPC C08K 3/32; C08L 91/00; C08K 2003/323; C08K 2003/329; C08L 2201/02

(57) ABSTRACT

A thermoplastic elastomer (TPE) is disclosed which is flame retardant and essentially halogen-free.

### CLAIM OF PRIORITY

This application claims the benefit of U.S. Provisional Patent Application Ser. No. 62/915,167 bearing Attorney Docket Number 12019013 and filed on Oct. 15, 2019, which is hereby incorporated by reference in its entirety.

### FIELD OF THE INVENTION

This invention relates to thermoplastic elastomers, polymer compounds which exhibit elasticity while remaining thermoplastic, which are also flame retardant.

### BACKGROUND OF THE INVENTION

There are many non-halogenated flame retardant (NHFR) combinations commercially available, however, there are few tailored to work effectively in oil-extended thermoplastic elastomer systems possessing shore A durometer. Adding oil to a thermoplastic system makes it more difficult to flame retard, however there are many benefits to have an increased amount of oil in a system, including reduced cost. Therefore, there is a need for an effective flame retardant polymer composition that provides excellent UL-94 vertical burn and IEC 60695-2-12 glow wire test performance for oil-extended thermoplastic elastomers.

### SUMMARY OF THE INVENTION

What the art needs is a new thermoplastic elastomer (also called “TPE”) that is flame retardant without the use of brominated flame retardants or chlorinated polyethylene flame retardants or other halogen-containing flame retardants. The art needs an essentially halogen-free flame retardant TPE (“HFFR TPE”).

“Essentially halogen-free” means that there is no intention to include any halogen moieties in any of the ingredients of the compound of the present invention, but that one can cannot control trace amounts of impurities that may exist in such ingredients.

Unfortunately, essentially halogen-free flame retardants are very sensitive to processing conditions typically experienced by TPEs.

In one embodiment, the present technology discloses a flame retardant polymer composition including up to about 20 wt. % polypropylene, based on total weight of the composition, a thermoplastic elastomer, an oil, and a flame retardant system including ammonium polyphosphate, a phosphinate salt, and a oligomer or polymer of a 1,3,5-triazine derivative.

The oligomer or polymer of a 1,3,5-triazine derivative may have a aliphatic or aromatic heterocyclic compounds containing at least one heteroatom, such as piperidino and morpholino residues and/or derivatives thereof, and is covalently bonded to the triazine ring through said heteroatom, and divalent linking groups selected from primary or secondary diamine compounds, linear or cyclic in nature, wherein the preferred divalent linking group is derived from piperazine. The ammonium polyphosphate may be the crystalline form II.

The phosphinate salt may include Mg, Ca, Al, Sb, Sn, Ge, Zn, Mo, Ti, Fe, Zr, Ce, Bi, Sr, Mn, Li, Na, K, or a protonated nitrogen base.

The flame retardant polymer composition may include about 15 to about 28.5 wt. % ammonium polyphosphate, about 4 to about 15 wt. % phosphinate salt and about 2.5 to about 15 wt. % triazine-based copolymer based on the total weight of the polymer composition.

The flame retardant polymer composition may include about 20.5 to about 25.5 wt. % ammonium polyphosphate, about 5.5 to about 11.5 wt. % phosphinate salt and about 4 to about 12.5 wt. % triazine-based copolymer based on the total weight of the polymer composition.

The flame retardant polymer composition may include about 19.5 to about 27 wt. % ammonium polyphosphate, about 6 to about 10 wt. % phosphinate salt and about 6 to about 10 wt. % triazine-based copolymer based on the total weight of the polymer composition.

The flame retardant polymer composition may include about 10 to about 40 wt. % thermoplastic elastomer, based on total weight of the composition.

The flame retardant polymer composition may include up to about 40 wt. % oil, based on total weight of the composition.

The flame retardant polymer composition may include about 10 to about 70 wt. % flame retardant system, based on total weight of the composition.

The thermoplastic elastomer of the flame retardant polymer composition may be selected from styrenic block copolymers, thermoplastic polyolefins, propylene/α-olefin copolymers, ethylene/α-olefin copolymers, copolyesters, thermoplastic polyurethanes, copolyamides, olefin block copolymers, low-density polyethylene, high density polyethylene and combinations of two or more of these thermoplastic elastomers.

The flame retardant polymer composition may include about zero to about 5 wt. % of at least one additive, based on the total weight of the compound. The additive may be selected from adhesion promoters; biocides; anti-fogging agents; anti-static agents; anti-oxidants; bonding, blowing and foaming agents; dispersants; fillers and extenders; smoke suppressants; impact modifiers; initiators; lubricants; micas; pigments, colorants and dyes; processing aids; release agents; silanes, titanates and zirconates; slip agents, anti-blocking agents; stabilizers; stearates; ultraviolet light absorbers; viscosity regulators; waxes; catalyst deactivators, and combinations of two or more thereof.

In an embodiment, the present technology discloses a molded article made from the flame retardant polymer composition.

In an embodiment, the present technology discloses an extruded article made from the flame retardant polymer composition.

In an embodiment, the present technology discloses a calendared article made from the flame retardant polymer composition.

In an embodiment, the present technology discloses a thermoformed article made from the flame retardant polymer composition.

In an aspect, the present technology discloses a method of using the flame retardant polymer composition including shaping the compound into an article designed to resist combustion or molten dripping in the presence of flame. The shaping may include extruding, molding, calendaring, or thermoforming.

Features of the invention will become apparent with reference to the following embodiments. There exist various refinements of the features noted in relation to the above-mentioned aspects of the disclosed invention. Additional features may also be incorporated in the above-mentioned aspects of the disclosed invention. These refinements and additional features may exist individually or in any combination. For instance, various features discussed below in relation to any of the described aspects of the invention may be incorporated into any of the described aspects of the invention alone or in any combination.

### EMBODIMENTS OF THE INVENTION

In some embodiments, the invention is directed to flame retardant polymer compounds.

In other embodiments, the invention is directed to flame retardant polymer articles.

In further embodiments, the invention is directed to methods of making flame retardant polymer articles.

Required and optional features of these and other embodiments of the disclosed invention are described.

As used herein, the term “compound” means a composition or mixture resulting from melt mixing, or compounding, a neat polymer resin and at least one other ingredient including but not limited to one or more additives, or one or more other polymer resins, or both.

As used herein, the term “formed from” (including related terms such as “forming”) means, with respect to an article (or component of an article) and a thermoplastic material, that the article (or component of the article) is extruded, molded, shaped, pressed, or otherwise made from the thermoplastic material under sufficient heating to enable such forming. As such, the term “formed from” (including related terms such as “forming”) means, in some embodiments, the article (or component of an article) can comprise, consist essentially of, or consist of, the material; and, in other embodiments, the article (or component of an article) consists of the material because the article (or component of an article) is, for example, made by an extrusion process or a molding process.

As used herein, the term “free of” a certain component or substance means, in some embodiments, that no amount of that component or substance is intentionally present, and, in other embodiments, that no functionally effective amount of that component or substance is present, and, in further embodiments, that no amount of that component or substance is present.

As used herein, the term “Hardness” means the hardness of a specimen as determined according to ASTM D2240. Hardness is reported as Shore A hardness unless specifically identified otherwise.

As used herein, the term “compound” means a composition or mixture resulting from melt mixing, or compounding, a neat polymer and at least one other ingredient including but not limited to one or more additives, or one or more other polymers, or both.

As used herein, the term “molded from” means, with respect to an article (or component of an article) and a material, that the article (or component of the article) is molded, extruded, shaped, formed, or otherwise made from the material. As such, the term “molded from” means, in some embodiments, the article (or component of an article) can comprise, consist essentially of, or consist of, the material; and, in other embodiments, the article (or component of an article) consists of the material because the article (or component of an article) is, for example, made by an injection molding process.

The present technology provides flame retardant polymer composition suitable for use in electrical and electronic (“E&E”) applications. The flame retardant polymer composition may include a polypropylene, a thermoplastic elastomer, an oil, a flame retardant system including ammonium polyphosphate, a phosphinate salt and a oligomer or polymer of a 1,3,5-triazine derivative, and optional additives. Each of such ingredients may comprise a single component or several different components. For example, in an embodiment, the thermoplastic elastomer may include at least two different thermoplastic elastomers, e.g., a styrenic block copolymer and a olefin block copolymer. The flame retardant polymer composition may not include all of the above components. The flame retardant polymer composition may include additional components beyond those discussed above.

The flame retardant polymer composition has many benefits, including, but not limited to, providing a non-halogenated flame retardant (NHFR) combination tailored to work effectively in an oil-extended thermoplastic elastomer system possessing shore A durometer. The flame retardant polymer compositions of the present invention are char forming and substantially nondripping when burned.

### Polypropylene

Polypropylene is an economical material that offers a combination of outstanding physical, mechanical, thermal, and electrical properties not found in other thermoplastics. For purposes of this invention, polypropylene is intended to cover the homopolymer of propylene as well as various copolymers of propylene and another a-olefin such as ethylene, butylene and the like or mixtures of homopolymer and copolymer. The copolymers can be random copolymers or block copolymers wherein the blocks themselves may be either homopolymers or random copolymers.

There are numerous commercial manufacturers of polypropylene, including Lyondell Basell Industries N.V., Exxon Mobil Corporation, Ineos, Flint Hills Resources, LLC, Formosa Plastics Corporation, Continental Chemical, Sunoco Chemicals, Braskem, Total, Mitsui Chemical and Chisso Chemical Corporation.

The amount of polypropylene in the flame retardant polymer composition may be any appropriate amount, including but not limited to, zero to about 20 wt. % of the flame retardant polymer composition; about 2 to about 18 wt. % of the flame retardant polymer composition; about 4 to about 16 wt. % of the flame retardant polymer composition; about 6 to about 14 wt. % of the flame retardant polymer composition; and about 8 to about 12 wt. % of the flame retardant polymer composition.

The amount of polypropylene may be kept below about 20 wt. % of the flame retardant polymer composition to keep the hardness within a desirable Shore A range. If the amount of polypropylene is increased much more than 20 wt. % of the flame retardant polymer composition, the end product may have a hardness in the Shore D range.

### Thermoplastic Elastomer

Thermoplastic elastomers (TPEs), which are polymer materials that exhibit elasticity while remaining thermoplastic. Any conventional thermoplastic elastomer is suitable for use the present technology, including, but not limited to, styrenic block copolymers, thermoplastic polyolefins, propylene/α-olefin copolymers, ethylene/α-olefin copolymers, copolyesters, thermoplastic polyurethanes, copolymaides, olefin block copolymers, low density polyethylene, high density polyethylene and combinations thereof. The polymers can be homopolymers or copolymers of any structure.

Non-limiting examples of suitable styrenic block copolymers include styrene-ethylene/butylene-styrene (SEBS), styrene-ethylene/propylene-styrene (SEPS), styrene-ethylene/ethylene/propylene-styrene (SEEPS), styrene-isobutylene-styrene (SIBS), styrene-butadiene-styrene (SBS), styrene-isoprene-styrene (SIS), and combinations thereof.

Non-limiting examples of suitable polyolefin elastomer include propylene-based elastomers, ethylene/α-olefin random copolymers, and combinations thereof.

Non-limiting examples of suitable copolyesters include block copolymers composed from repeating soft segments of aliphatic polyether or aliphatic polyester and hard segments of aromatic polyester.

In some embodiments, a single thermoplastic elastomer may be used. In some embodiments, a combination of two or more thermoplastic elastomers may be used.

There are numerous commercial manufacturers of thermoplastic elastomers, including, but not limited to, Kraton™ G1640 ES from Kraton Polymers LLC, Globalprene™ 7551 or Globalprene™ 9551 from LCY Chemical Corporation, Taipol™ 6159 from TSRC Corporation, Infuse™ 9100 from The Dow Chemical Company, or Vistamaxx™ 6502 from Exxon Mobil Corporation.

The amount of thermoplastic elastomer in the flame retardant polymer composition may be any appropriate amount, including but not limited to about 10 to about 40 wt. % of the flame retardant polymer composition; about 15 to about 35 wt. % of the flame retardant polymer composition; about 20 to about 30 wt. % of the flame retardant polymer composition; and about 23 to about 27 wt. % of the flame retardant polymer composition. The amount of thermoplastic elastomer may be varied based on the desired physical properties of the resulting flame retardant polymer composition.

### Flame Retardant System

The flame retardant system of the present invention may include ammonium polyphosphate (“APP”), phosphinate salt, and an oligomer or polymer of a 1,3,5-triazine derivative. The flame retardant system may include fewer than these three components, or may include additional components.

The amount of flame retardant system in the flame retardant polymer composition may be any appropriate amount, including but not limited to about 10 to about 70 wt. % of the flame retardant polymer composition; about 20 to about 60 wt. % of the flame retardant polymer composition; 30 to about 50 wt. % of the flame retardant polymer composition; and about 35 to about 45 wt. % of the flame retardant polymer composition.

### Ammonium Polyphosphate

Ammonium polyphosphates are inorganic salts that are produced from the reaction of polyphosphoric acid and ammonia and has the chemical formula [NH₄PO₃]ₙ. Ammonium polyphosphates can be used as a flame retardant system. When exposed to heat or fire, ammonium polyphosphate will begin to decompose back to ammonia and phosphoric acid. The phosphoric acid acts as a catalyst in the dehydration of carbon-based poly-alcohols. The phosphoric acid reacts with such alcohol groups to form phosphate esters, which further decompose to release carbon dioxide. The release of non-flammable carbon dioxide, as well as nitrogen further degraded from ammonia and water, reduces the amount of available oxygen to the material that is burning. In contrast, halogen-based systems would result in the release of gases that contained halogens into the environment.

In an embodiment, the ammonium polyphosphate may be of the crystalline form II. The ammonium polyphosphate may have a very high molecular weight.

Ammonium polyphosphates are commercially available from several manufactures, including JLS Chemicals which offers APP-JLS, JLS PNPIC, JLS PNP2V, and JLS PNP3D. Other commercial products are Clariant Exolit® AP, Amfine™ FP, Budenheim Budit™, Chitec Zuran®, and JJI JJAZZ™.

For the present invention, the flame retardant system can contain more than one type of ammonium polyphosphate or a blend containing ammonium polyphosphate.

The amount of ammonium polyphosphate in the flame retardant polymer composition may be any appropriate amount, including but not limited to about 15 to about 28.5 wt. % of the flame retardant polymer composition; about 19.5 to about 27 wt. % of the flame retardant polymer composition; and about 20.5 to about 25.5 wt. % of the flame retardant polymer composition.

### Phosphinate Salt

Phosphinate salts can be used in the present flame retardant system. When exposed to heat or fire, phosphinate salts act as a flame retardant by contributing to charring of a polymer matrix and thereby protecting the substrate against heat and oxygen attack. The phosphinate may both partially vaporize and partially decompose and act as a barrier for fuel and heat transport.

In an embodiment of the present invention, the phosphinate salt may include Mg, Ca, Al, Sb, Sn, Ge, Zn, Mo, Ti, Fe, Zr, Ce, Bi, Sr, Mn, Li, Na, K, or a protonated nitrogen base.

In an embodiment of the present invention, the phosphinate salt may be aluminum diethyl phosphinate acid aluminum salt.

For the present invention, the flame retardant system can contain more than one type of phosphinate salt.

There are numerous commercial manufacturers of phosphinate salts, including Exolit™ OP 1230 from Clariant AG.

The amount of phosphinate salt in the flame retardant polymer composition may be any appropriate amount, including but not limited to about 4 to about 15 wt. % of the flame retardant polymer composition; about 5.5 to about 11.5 wt. % of the flame retardant polymer composition; and about 6 to about 10 wt. % of the flame retardant polymer composition.

### Oligomer or Polymer of a 1,3,5-Triazine Derivative

Oligomers or polymers of a 1,3,5-triazine derivative can be used in the present flame retardant system. When exposed to heat or fire, phosphinate salts act as a flame retardant by contributing to charring of a polymer matrix and thereby protecting the substrate against heat and oxygen attack. The phosphinate may both partially vaporize and partially decompose and act as a barrier for fuel and heat transport.

In an embodiment of the present invention, the oligomer or polymer of a 1,3,5-triazine derivative may include an aliphatic or aromatic heterocyclic compounds containing at least one heteroatom, such as piperidino and morpholino residues and/or derivatives thereof, and is covalently bonded to the triazine ring through said heteroatom, and a divalent linking group selected from primary or secondary diamine compounds, linear or cyclic in nature. In an embodiment, the divalent linking group may be derived from piperazine.

In an embodiment of the present invention, the oligomer or polymer of a 1,3,5-triazine derivative may be a triazine based copolymer.

For the present invention, the flame retardant system can contain more than one type of oligomers or polymers of a 1,3,5-triazine derivative.

The amount of oligomer or polymer of a 1,3,5-triazine derivative in the flame retardant polymer composition may be any appropriate amount, including but not limited to about 2.5 to about 15 wt. % of the flame retardant polymer composition; about 4 to about 12.5 wt. % of the flame retardant polymer composition; and about 6 to about 10 wt. % of the flame retardant polymer composition.

### Oil

Any conventional plasticizer, preferably a paraffinic oil, is suitable for use the present technology. The plasticizer may be used, for example, to adjust softness and/or improve flow or other properties of the thermoplastic elastomer gel compound. Any conventional oil capable of plasticizing styrenic block copolymer, such as mineral oil, vegetable oil, synthetic oil, etc., may be used in the present invention. Examples of commercially available oils include those available under the PURETOL™ 380 brand from Petro-Canada™, and those available under the PRIMOL™ 382 brand from Exxon Mobil Corporation.

In some embodiments, plasticizers with a higher molecular weight than that of the aforementioned conventional oils may be used. Polyisobutene (PIB) is an example of such a plasticizer with a relatively higher molecular weight. For example, medium- to high-molecular weight PIB is commercially available under the OPPANOL™ brand from BASF™.

The amount of polypropylene in the flame retardant polymer composition may be any appropriate amount, including but not limited to, zero to about 40 wt. % of the flame retardant polymer composition; about 5 to about 35 wt. % of the flame retardant polymer composition; about 10 to about 30 wt. % of the flame retardant polymer composition; about 15 to about 25 wt. % of the flame retardant polymer composition; and about 18 to about 22 wt. % of the flame retardant polymer composition.

The amount of thermoplastic elastomer may be varied for various reasons, including, but not limited to, aid in processing, function as a plasticizer, and/or to reduce cost.

### Optional Additives

In some embodiments, the polymer composition further include one or more optional additives.

Suitable optional additives include conventional or commercially available plastics additives. Those skilled in the art of thermoplastics compounding, without undue experimentation, can select suitable additives from available references, for example, E.W. Flick, “Plastics Additives Database,” Plastics Design Library (Elsevier 2004).

Optional additives can be used in any amount that is sufficient to obtain a desired processing or performance property for the thermoplastic polyurethane compound and/or the thermoplastic article molded therefrom. The amount should not be wasteful of the additive nor detrimental to the processing or performance of the thermoplastic polyurethane compound and/or the thermoplastic article molded therefrom.

Non-limiting examples of optional additives include adhesion promoters; anti-fogging agents; antioxidants; anti-static agents; biocides (antibacterials, fungicides, and mildewcides); colorants including pigments and dyes; dispersants; fillers and extenders; fire and flame retardants and smoke suppressants; hardness adjusters; impact modifiers; initiators; lubricants; micas; mold release agents; oils and plasticizers; processing aids; secondary polymers; silanes, titanates and zirconates; slip and anti-blocking agents; stabilizers; stearates; ultraviolet light absorbers; viscosity regulators; and waxes.

In some embodiments, the flame retardant polymer compositions further include one or more of antioxidants and stabilizers; colorants; mold release agents; ultraviolet light absorbers; and combinations thereof.

The amount of additives in the flame retardant polymer composition may be any appropriate amount, including but not limited to, zero to about 10 wt. % of the flame retardant polymer composition; about 2 to about 8 wt. % of the flame retardant polymer composition; and about 4 to about 6 wt. % of the flame retardant polymer composition.

### Ranges of Ingredients in the Polymer Composition

Table 1 below shows ranges of ingredients, in wt. %, which can be acceptable, desirable, and preferable for some embodiments of flame retardant polymer composition of the disclosed invention. Other possible ranges of ingredients for other embodiments of the disclosed invention are as described elsewhere herein.

Flame retardant polymer compositions, in some embodiments, can comprise, consist essentially of, or consist of these ingredients. Any number between the ends of the ranges is also contemplated as an end of a range, such that all possible combinations are contemplated within the possibilities of Table 1 as embodiments of compounds for use in the disclosed invention. Unless expressly stated otherwise herein, any disclosed number is intended to refer to both exactly the disclosed number and “about” the disclosed number, such that either possibility is contemplated within the possibilities of Table 1 as embodiments of compounds for use in the disclosed invention.

TABLE 1
Polymer Composition
(Wt. %)

| Ingredient | Acceptable | Desirable | Preferable |
|---|---|---|---|
| Polypropylene | 0-40 | 5-35 | 15-30 |
| Thermoplastic Elastomer | 10-40 | 10-40 | 25-35 |
| Ammonium Polyphosphate | 15-28.5 | 19.5-27 | 20.5-25.5 |
| Phosphinate Salt | 4-15 | 5.5-11.5 | 6-10 |
| Oligomer or polymer of a 1,3,5- | 2.5-15 | 4-11.5 | 6-10 |
| triazine derivative | | | |
| Oil | 0-40 | 5-35 | 15-30 |
| Optional Additives | 0-10 | 1-8 | 3-6 |

### Processing and Methods of Making

Preparation of thermoplastic polyurethane compounds of the disclosed invention is uncomplicated once the proper ingredients have been selected. The compound can be made in batch or continuous operations.

Mixing in a continuous process typically occurs in an extruder that is elevated to a temperature that is sufficient to melt the polymer matrix with addition of all additives at the feed-throat, or by injection or side-feeders downstream. Extruder speeds can range from about 200 to about 700 revolutions per minute (rpm), for example, from about 250 rpm to about 350 rpm. Typically, the output from the extruder is pelletized for later processing into thermoplastic articles.

Subsequent preparation of thermoplastic articles of the disclosed invention also is uncomplicated once thermoplastic polyurethane compounds of the present invention are provided. For example, thermoplastic articles of the present invention can be made by injection molding, extrusion, blow molding, rotational molding, thermoforming, calendaring, and the like.

Processing techniques are described in available references, for example, Dominick V. Rosato et al., Plastics Design Handbook (Springer 2013).

In some embodiments, thermoplastic elastomer compounds of the disclosed invention are molded by injection molding processes into thermoplastic articles.

Further aspects of the invention are directed to overmolded articles made by overmolding processes.

According to the invention, the overmolded articles include (a) an overmold portion including the thermoplastic article of any embodiments of the disclosed invention, and (b) a substrate portion molded from a thermoplastic resin compound. The overmold portion is bonded onto the substrate portion at a bond interface, and the bond interface is free of adhesive.

### Usefulness of the Invention

Flame retardant polymer compositions of the disclosed invention can be useful for making any type of thermoplastic article, or any thermoplastic component of a multi-component article or device, for which properties such as flame resistance, reduced mold deposit, and improved UV stability are desirable or required. The present flame retardant polymer composition may also provide a benefit over currently available flame retardant polymer compositions which do now have the same thermoplastic elastomer properties, e.g., hardness. Additionally, the present invention may be more cost effective than other competitive products.

Flame retardant polymer compositions of the disclosed invention have potential for use in applications in many different industries, including but not limited to: electrical and electronic; automotive and transportation; consumer products; electronics; healthcare and medical; household appliances; and other industries or applications benefiting from the unique combination of properties.

In some embodiments, flame retardant polymer compositions of the present invention can be especially useful for making films, fibers and filaments; wire and cable coatings; automotive and transportation components; components for household appliances, connectors in electrical or electronic applications; components for electronic devices, such as computers; or any other suitable application.

### EXAMPLES

Non-limiting examples of polymer compositions of various embodiments of the disclosed invention are provided.

Tables 2-11 shows formulations for the Examples and Comparative Examples. Examples 1-4 show formulations with the flame retardant system and thermoplastic elastomer components. Comparative Examples 1-8 show formulations for both the thermoplastic elastomer and flame retardant system components. Examples 5-20 show the expanded range of thermoplastic elastomer components. Comparative Examples 9-25 show the optimization of the flame retardant.

As shown below, the resulting flame retardant polymer compositions of the present invention are char forming and substantially nondripping when burned.

TABLE 2
Formulations of Examples and Comparative Examples

| Ingredient (% of total | Comparative | Comparative | Example | Example | Comparative | Comparative |
|---|---|---|---|---|---|---|
| composition) | Example 1 | Example 2 | 1 | 2 | Example 3 | Example 4 |
| poly(styrene-ethylene- | 22.74 | 22.74 | 22.74 | 22.74 | 22.74 | 22.74 |
| butylene-styrene) “SEBS” | | | | | | |
| white mineral oil | 29.57 | 29.57 | 29.57 | 29.57 | 29.57 | 29.57 |
| polypropylene | 7.00 | 7.00 | 7.00 | 7.00 | 7.00 | 7.00 |
| aluminum | 12.16 | 12.16 | 12.16 | 12.16 | 0.00 | 5.00 |
| diethylphosphinate | | | | | | |
| “DEPAL” | | | | | | |
| ammonium polyphosphate | 17.04 | 17.04 | 0.00 | 0.00 | 30.00 | 26.25 |
| (phase II) “APP” | | | | | | |
| poly-[2,4-(piperazine-1,4- | 10.80 | 10.80 | 0.00 | 0.00 | 10.00 | 8.75 |
| yl)-6-(morpholine-4-yl)- | | | | | | |
| 1,3,5-triazine] | | | | | | |
| blend of APP and poly- | 0.00 | 0.00 | 27.84 | 27.84 | 0.00 | 0.00 |
| [2,4-(piperazine-1,4-yl)-6- | | | | | | |
| (morpholine-4-y1)-1,3,5- | | | | | | |
| triazine] | | | | | | |
| Didodecyl 3,3′- | 0.20 | 0.20 | 0.20 | 0.20 | 0.20 | 0.20 |
| thiodipropionate | | | | | | |
| Pentaerythritol tetrakis(3- | 0.20 | 0.20 | 0.20 | 0.20 | 0.20 | 0.20 |
| (3,5-di-tert-butyl-4- | | | | | | |
| hydroxyphenyl)propionate) | | | | | | |
| Erucamide | 0.29 | 0.29 | 0.29 | 0.29 | 0.29 | 0.29 |

TABLE 3
Formulations of Examples and Comparative Examples

| Ingredient ( % of total | Example | Comparative | Comparative | Comparative | Comparative | Example |
|---|---|---|---|---|---|---|
| composition) | 3 | Example 5 | Example 6 | Example 7 | Example 8 | 4 |
| poly(styrene-ethylene- | 22.74 | 22.74 | 22.74 | 22.74 | 22.74 | 22.74 |
| butylene-styrene) “SEBS” | | | | | | |
| white mineral oil | 29.57 | 29.57 | 29.57 | 29.57 | 29.57 | 29.57 |
| polypropylene | 7.00 | 7.00 | 7.00 | 7.00 | 7.00 | 7.00 |
| aluminum | 10.00 | 15.00 | 20.00 | 30.00 | 40.00 | 10.00 |
| diethylphosphinate | | | | | | |
| “DEPAL” | | | | | | |
| ammonium polyphosphate | 22.50 | 18.75 | 15.00 | 7.50 | 0.00 | 22.50 |
| (phase II) “APP” | | | | | | |
| poly-[2,4-(piperazine-1,4- | 7.50 | 6.25 | 5.00 | 2.50 | 0.00 | 7.50 |
| yl)-6-(morpholine-4-yl)- | | | | | | |
| 1,3,5-triazine] | | | | | | |
| blend of APP and poly-[2,4- | 0.00 | 0.00 | 0.00 | 0.00 | 0.00 | 0.00 |
| (piperazine-1,4-yl)-6- | | | | | | |
| (morpholine-4-yl)-1,3,5- | | | | | | |
| triazine] | | | | | | |
| Didodecyl 3,3′- | 0.20 | 0.20 | 0.20 | 0.20 | 0.20 | 0.20 |
| thiodipropionate | | | | | | |
| Pentaerythritol tetrakis(3- | 0.20 | 0.20 | 0.20 | 0.20 | 0.20 | 0.20 |
| (3,5-di-tert-butyl-4- | | | | | | |
| hydroxyphenyl)propionate) | | | | | | |
| Erucamide | 0.29 | 0.29 | 0.29 | 0.29 | 0.29 | 0.29 |

TABLE 4
Formulations of Comparative Examples

| Ingredient ( % of total | Comparative | Comparative | Comparative | Comparative | Comparative |
|---|---|---|---|---|---|
| composition) | Example 9 | Example 10 | Example 11 | Example 12 | Example 13 |
| poly(styrene-ethylene- | 22.74 | 22.74 | 22.74 | 22.74 | 22.74 |
| butylene-styrene) “SEBS” | | | | | |
| white mineral oil | 29.57 | 29.57 | 29.57 | 29.57 | 29.57 |
| polypropylene | 7.00 | 7.00 | 7.00 | 7.00 | 7.00 |
| aluminum | 8.98 | 11.90 | 15.00 | 15.00 | 5.39 |
| diethylphosphinate | | | | | |
| “DEPAL” | | | | | |
| ammonium polyphosphate | 24.16 | 18.10 | 20.37 | 25.00 | 30.00 |
| (phase II) “APP” | | | | | |
| poly-[2,4-(piperazine-1,4- | 6.86 | 10.00 | 4.63 | 0.00 | 4.61 |
| yl)-6-(morpholine-4-yl)- | | | | | |
| 1,3,5-triazine] | | | | | |
| blend of APP and poly-[2,4- | 0.00 | 0.00 | 0.00 | 0.00 | 0.00 |
| (piperazine-1,4-yl)-6- | | | | | |
| (morpholine-4-y1)-1,3,5- | | | | | |
| triazine] | | | | | |
| Didodecyl 3,3′- | 0.20 | 0.20 | 0.20 | 0.20 | 0.20 |
| thiodipropionate | | | | | |
| Pentaerythritol tetrakis(3- | 0.20 | 0.20 | 0.20 | 0.20 | 0.20 |
| (3,5-di-tert-butyl-4- | | | | | |
| hydroxyphenyl)propionate) | | | | | |
| Erucamide | 0.29 | 0.29 | 0.29 | 0.29 | 0.29 |

TABLE 5
Formulations of Comparative Examples

| Ingredient ( % of total | Comparative | Comparative | Comparative | Comparative | Comparative |
|---|---|---|---|---|---|
| composition) | Example 14 | Example 15 | Example 16 | Example 17 | Example 18 |
| poly(styrene-ethylene- | 22.74 | 22.74 | 22.74 | 22.74 | 22.74 |
| butylene-styrene) “SEBS” | | | | | |
| white mineral oil | 29.57 | 29.57 | 29.57 | 29.57 | 29.57 |
| polypropylene | 7.00 | 7.00 | 7.00 | 7.00 | 7.00 |
| aluminum diethylphosphinate | 15.00 | 15.00 | 11.83 | 7.32 | 10.00 |
| “DEPAL” | | | | | |
| ammonium polyphosphate | 15.00 | 25.00 | 20.97 | 22.68 | 30.00 |
| (phase II) “APP” | | | | | |
| poly-[2,4-(piperazine-1,4-y1)-6- | 10.00 | 0.00 | 7.20 | 10.00 | 0.00 |
| (morpholine-4-y1)-1,3,5- | | | | | |
| triazine] | | | | | |
| blend of APP and poly-[2,4- | 0.00 | 0.00 | 0.00 | 0.00 | 0.00 |
| (piperazine-1,4-yl)-6- | | | | | |
| (morpholine-4-y1)-1,3,5- | | | | | |
| triazine] | | | | | |
| Didodecyl 3,3′- | 0.20 | 0.20 | 0.20 | 0.20 | 0.20 |
| thiodipropionate | | | | | |
| Pentaerythritol tetrakis(3-(3,5- | 0.20 | 0.20 | 0.20 | 0.20 | 0.20 |
| di-tert-butyl-4- | | | | | |
| hydroxyphenyl)propionate) | | | | | |
| Erucamide | 0.29 | 0.29 | 0.29 | 0.29 | 0.29 |

TABLE 6
Formulations of Comparative Examples

| | Comparative | Comparative | Comparative | Comparative |
|---|---|---|---|---|
| Ingredient (% of total composition) | Example 19 | Example 20 | Example 21 | Example 22 |
| poly(styrene-ethylene-butylene-styrene) | 22.74 | 22.74 | 22.74 | 22.74 |
| “SEBS” | | | | |
| white mineral oil | 29.57 | 29.57 | 29.57 | 29.57 |
| polypropylene | 7.00 | 7.00 | 7.00 | 7.00 |
| aluminum diethylphosphinate “DEPAL” | 10.00 | 5.39 | 15.00 | 0.00 |
| ammonium polyphosphate (phase II) | 25.00 | 30.00 | 17.68 | 30.00 |
| “APP” | | | | |
| poly-[2,4-(piperazine-1,4-yl)-6- | 5.00 | 4.61 | 7.32 | 10.00 |
| (morpholine-4-yl)-1,3,5-triazine] | | | | |
| blend of APP and poly-[2,4-(piperazine- | 0.00 | 0.00 | 0.00 | 0.00 |
| 1,4-yl)-6-(morpholine-4-yl)-1,3,5- | | | | |
| triazine] | | | | |
| Didodecyl 3,3′-thiodipropionate | 0.20 | 0.20 | 0.20 | 0.20 |
| Pentaerythritol tetrakis(3-(3,5-di-tert- | 0.20 | 0.20 | 0.20 | 0.20 |
| butyl-4-hydroxyphenyl)propionate) | | | | |
| Erucamide | 0.29 | 0.29 | 0.29 | 0.29 |

TABLE 7
Formulations of Comparative Examples

| | Comparative | Comparative | Comparative |
|---|---|---|---|
| Ingredient (% of total composition) | Example 23 | Example 24 | Example 25 |
| poly(styrene-ethylene-butylene-styrene) | 22.74 | 22.74 | 22.74 |
| “SEBS” | | | |
| white mineral oil | 29.57 | 29.57 | 29.57 |
| polypropylene | 7.00 | 7.00 | 7.00 |
| aluminum diethylphosphinate “DEPAL” | 10.00 | 10.00 | 9.00 |
| ammonium polyphosphate (phase II) | 25.00 | 25.00 | 23.00 |
| “APP” | | | |
| poly-[2,4-(piperazine-1,4-yl)-6- | 5.00 | 5.00 | 8.00 |
| (morpholine-4-yl)-1,3,5-triazine] | | | |
| blend of APP and poly-[2,4-(piperazine- | 0.00 | 0.00 | 0.00 |
| 1,4-yl)-6-(morpholine-4-yl)-1,3,5- | | | |
| triazine] | | | |
| Didodecyl 3,3′-thiodipropionate | 0.20 | 0.20 | 0.20 |
| Pentaerythritol tetrakis(3-(3,5-di-tert- | 0.20 | 0.20 | 0.20 |
| butyl-4-hydroxyphenyl)propionate) | | | |
| Erucamide | 0.29 | 0.29 | 0.29 |

TABLE 8
Formulations of Examples

| Ingredient (% of total composition) | Example 5 | Example 6 | Example 7 | Example 8 | Example 9 |
|---|---|---|---|---|---|
| poly(styrene-ethylene-butylene-styrene) | 15.00 | 30.00 | 24.77 | 30.00 | 21.85 |
| “SEBS” | | | | | |
| white mineral oil | 30.00 | 21.85 | 24.77 | 29.31 | 22.46 |
| polypropylene | 14.31 | 7.46 | 9.77 | 0.00 | 15.00 |
| aluminum diethylphosphinate “DEPAL” | 0 | 0 | 0 | 0 | 0 |
| ammonium polyphosphate (phase II) | 0 | 0 | 0 | 0 | 0 |
| “APP” | | | | | |
| poly-[2,4-(piperazine-1,4-yl)-6- | 0 | 0 | 0 | 0 | 0 |
| (morpholine-4-yl)-1,3,5-triazine] | | | | | |
| blend of APP and poly-[2,4-(piperazine- | 0.00 | 0.00 | 0.00 | 0.00 | 0.00 |
| 1,4-yl)-6-(morpholine-4-yl)-1,3,5- | | | | | |
| triazine] | | | | | |
| Didodecyl 3,3′-thiodipropionate | 0.2 | 0.2 | 0.2 | 0.2 | 0.2 |
| Pentaerythritol tetrakis(3-(3,5-di-tert- | 0.2 | 0.2 | 0.2 | 0.2 | 0.2 |
| butyl-4-hydroxyphenyl)propionate) | | | | | |
| Erucamide | 0.29 | 0.29 | 0.29 | 0.29 | 0.29 |

TABLE 9
Formulations of Examples

| Ingredient (% of total composition) | Example 10 | Example 11 | Example 12 | Example 13 | Example 14 |
|---|---|---|---|---|---|
| poly(styrene-ethylene-butylene-styrene) | 22.50 | 30.00 | 21.85 | 15.00 | 26.83 |
| “SEBS” | | | | | |
| white mineral oil | 30.00 | 21.76 | 22.46 | 30.00 | 19.83 |
| polypropylene | 6.81 | 7.55 | 15.00 | 14.31 | 12.65 |
| aluminum diethylphosphinate “DEPAL” | 0 | 0 | 0 | 0 | 0 |
| ammonium polyphosphate (phase II) | 0 | 0 | 0 | 0 | 0 |
| “APP” | | | | | |
| poly-[2,4-(piperazine-1,4-yl)-6- | 0 | 0 | 0 | 0 | 0 |
| (morpholine-4-yl)-1,3,5-triazine] | | | | | |
| blend of APP and poly-[2,4-(piperazine- | 0.00 | 0.00 | 0.00 | 0.00 | 0.00 |
| 1,4-yl)-6-(morpholine-4-yl)-1,3,5- | | | | | |
| triazine] | | | | | |
| Didodecyl 3,3′-thiodipropionate | 0.2 | 0.2 | 0.2 | 0.2 | 0.2 |
| Pentaerythritol tetrakis(3-(3,5-di-tert- | 0.2 | 0.2 | 0.2 | 0.2 | 0.2 |
| butyl-4-hydroxyphenyl)propionate) | | | | | |
| Erucamide | 0.29 | 0.29 | 0.29 | 0.29 | 0.29 |

TABLE 10
Formulations of Examples

| Ingredient (% of total composition) | Example 15 | Example 16 | Example 17 | Example 18 |
|---|---|---|---|---|
| poly(styrene-ethylene-butylene-styrene) | 27.35 | 29.31 | 30.00 | 22.50 |
| “SEBS” | | | | |
| white mineral oil | 27.10 | 15.00 | 29.31 | 30.00 |
| polypropylene | 4.86 | 15.00 | 0.00 | 6.81 |
| aluminum diethylphosphinate “DEPAL” | 0 | 0 | 0 | 0 |
| ammonium polyphosphate (phase II) | 0 | 0 | 0 | 0 |
| “APP” | | | | |
| poly-[2,4-(piperazine-1,4-yl)-6- | 0 | 0 | 0 | 0 |
| (morpholine-4-yl)-1,3,5-triazine] | | | | |
| blend of APP and poly-[2,4-(piperazine- | 0.00 | 0.00 | 0.00 | 0.00 |
| 1,4-yl)-6-(morpholine-4-yl)-1,3,5- | | | | |
| triazine] | | | | |
| Didodecyl 3,3′-thiodipropionate | 0.2 | 0.2 | 0.2 | 0.2 |
| Pentaerythritol tetrakis(3-(3,5-di-tert- | 0.2 | 0.2 | 0.2 | 0.2 |
| butyl-4-hydroxyphenyl)propionate) | | | | |
| Erucamide | 0.29 | 0.29 | 0.29 | 0.29 |

TABLE 11
Formulations of Examples

| Ingredient (% of total composition) | Example 19 | Example 20 |
|---|---|---|
| poly(styrene-ethylene-butylene-styrene) | 19.86 | 24.77 |
| “SEBS” | | |
| white mineral oil | 27.31 | 24.77 |
| polypropylene | 12.15 | 9.77 |
| aluminum diethylphosphinate “DEPAL” | 0 | 0 |
| ammonium polyphosphate (phase II) | 0 | 0 |
| “APP” | | |
| poly-[2,4-(piperazine-1,4-yl)-6- | 0 | 0 |
| (morpholine-4-yl)-1,3,5-triazine] | | |
| blend of APP and poly-[2,4-(piperazine- | 0.00 | 0.00 |
| 1,4-yl)-6-(morpholine-4-yl)-1,3,5- | | |
| triazine] | | |
| Didodecyl 3,3′-thiodipropionate | 0.2 | 0.2 |
| Pentaerythritol tetrakis(3-(3,5-di-tert- | 0.2 | 0.2 |
| butyl-4-hydroxyphenyl)propionate) | | |
| Erucamide | 0.29 | 0.29 |

TABLE 12
Test Results

| | | | Comparative | Comparative | Example | Example |
|---|---|---|---|---|---|---|
| Test | Method | Units | Example 1 | Example 2 | 1 | 2 |
| Tensile Strength @ | Tensile - ASTM | psi | 429 | 436 | 431 | 538 |
| Yield, Perpendicular | D412 | | | | | |
| Tensile Elongation a | Tensile - ASTM | % | 497 | 510 | 588 | 686 |
| Break, Perpendicular | D412 | | | | | |
| Tensile Strength @ | Tensile - ASTM | psi | 379 | 353 | 310 | 374 |
| Yield, Parallel | D412 | | | | | |
| Tensile Elongation @ | Tensile - ASTM | % | 228 | 258 | 291 | 401 |
| Break, Parallel | D412 | | | | | |
| Hardness, Shore A, | Durometer | | 67 | 64 | 61 | 61 |
| Instantaneous | Hardness - (Shore | | | | | |
| | A) ASTM D2240 | | | | | |
| Hardness, Shore A | Durometer | | 61 | 57 | 54 | 54 |
| (delay) (10 s) | Hardness - (Shore | | | | | |
| | A) ASTM D2240 | | | | | |
| Glow Wire Test (1.6 | Glow Wire Test - | ° C. | | | | pass |
| mm, 850° C.) | IEC 60695-2-12 | | | | | |
| Glow Wire Test (1.6 | Glow Wire Test - | s | | | | 14 |
| mm, 850° C.) Average | IEC 60695-2-12 | | | | | |
| Afterflame Time | | | | | | |
| Glow Wire Test 1.6 | Glow Wire Test - | ° C. | | | | |
| mm, 960° C.) GWFI | IEC 60695-2-12 | | | | | |
| Glow Wire Test (1.6 | Glow Wire Test - | s | | | | |
| mm, 960° C.) Average | IEC 60695-2-12 | | | | | |
| Afterflame Time | | | | | | |
| 20 mm Vertical Burn, | Vertical Burn(20 | | V-0 | V- | V-0 | V-0 |
| 3.2 mm | mm)-UL94 | | | | | |
| 20 mm Vertical Burn, | Vertical Burn(20 | | V-2 | V-2 | V-0 | V-0 |
| 1.6 mm | mm)-UL94 | | | | | |
| 20 mm Vertical Burn, | Vertical Burn(20 | s | 47 | 31 | 10 | 5 |
| 1.6 mm Cummulative | mm)-UL94 | | | | | |
| Afterflame Time | | | | | | |
| 20 mm Vertical Burn, | Vertical Burn(20 | | | | | |
| 0.8 mm | mm)-UL94 | | | | | |
| 20 mm Vertical Burn, | Vertical Burn(20 | s | | | | |
| 0.8 mm Cummulative | mm)-UL94 | | | | | |
| Afterflame Time | | | | | | |

TABLE 13
Test Results

| | | | Comparative | Comparative | Example | Comparative |
|---|---|---|---|---|---|---|
| Test | Method | Units | Example 3 | Example 4 | 3 | Example 5 |
| Tensile Strength @ | Tensile - ASTM | psi | 511 | 569 | 550 | 558 |
| Yield, Perpendicular | D412 | | | | | |
| Tensile Elongation | Tensile - ASTM | % | 657 | 732 | 709 | 723 |
| @ Break, | D412 | | | | | |
| Perpendicular | | | | | | |
| Tensile Strength @ | Tensile - ASTM | psi | 359 | 347 | 366 | 334 |
| Yield, Parallel | D412 | | | | | |
| Tensile Elongation | Tensile - ASTM | % | 281 | 356 | 438 | 426 |
| @ Break, Parallel | D412 | | | | | |
| Hardness, Shore A, | Durometer | | 65 | 64 | 62 | 63 |
| Instantaneous | Hardness - (Shore | | | | | |
| | A) ASTM D2240 | | | | | |
| Hardness, Shore A | Durometer | | 58 | 56 | 55 | 56 |
| (delay) (10 s) | Hardness - (Shore | | | | | |
| | A) ASTM D2240 | | | | | |
| Glow Wire Test (1.6 | Glow Wire Test - | | pass | pass | pass | pass |
| mm, 850° C.) | IEC 60695-2-12 | | | | | |
| Glow Wire Test (1.6 | Glow Wire Test - | s | 30 | 31 | 14 | 54 |
| mm, 850° C.) | IEC 60695-2-12 | | | | | |
| Average Afterflame | | | | | | |
| Time | | | | | | |
| Glow Wire Test 1.6 | Glow Wire Test - | ° C. | | | | |
| mm, 960° C.) GWFI | IEC 60695-2-12 | | | | | |
| Glow Wire Test (1.6 | Glow Wire Test - | s | | | | |
| mm, 960° C.) | IEC 60695-2-12 | | | | | |
| Average Afterflame | | | | | | |
| Time | | | | | | |
| 20 mm Vertical | Vertical Burn(20 | | V-0 | V-0 | V-C | V-0 |
| Burn, 3.2 mm | mm)-UL94 | | | | | |
| 20 mm Vertical | Vertical Burn(20 | | NR | V-2 | V-0 | NR |
| Burn, 1.6 mm | mm)-UL94 | | | | | |
| 20 mm Vertical | Vertical Burn(20 | s | — | 47 | 16 | 59 |
| Burn, 1.6 mm | mm)-UL94 | | | | | |
| Cummulative | | | | | | |
| Afterflame Time | | | | | | |
| 20 mm Vertical | Vertical Burn(20 | | | | | |
| Burn, 0.8 mm | mm)-UL94 | | | | | |
| 20 mm Vertical | Vertical Burn(20 | s | | | | |
| Burn, 0.8 mm | mm)-UL94 | | | | | |
| Cummulative | | | | | | |
| Afterflame Time | | | | | | |

TABLE 14
Test Results

| | | | Comparative | Comparative | Comparative |
|---|---|---|---|---|---|
| Test | Method | Units | Example 6 | Example 7 | Example 8 |
| Tensile Strength @ | Tensile - ASTM | psi | 559 | 533 | 553 |
| Yield, Perpendicular | D412 | | | | |
| Tensile Elongation @ | Tensile - ASTM | % | 730 | 698 | 728 |
| Break, Perpendicular | D412 | | | | |
| Tensile Strength @ | Tensile - ASTM | psi | 319 | 320 | 301 |
| Yield, Parallel | D412 | | | | |
| Tensile Elongation @ | Tensile - ASTM | % | 458 | 515 | 470 |
| Break, Parallel | D412 | | | | |
| Hardness, Shore A, | Durometer | | 63 | 63 | 64 |
| Instantaneous | Hardness - (Shore | | | | |
| | A) ASTM D2240 | | | | |
| Hardness, Shore A | Durometer | | 55 | 56 | 56 |
| (delay) (10 s) | Hardness - (Shore | | | | |
| | A) ASTM D2240 | | | | |
| Glow Wire Test (1.6 | Glow Wire Test - | ° C. | pass | pass | pass |
| mm, 850° C.) | IEC 60695-2-12 | | | | |
| Glow Wire Test (1.6 | Glow Wire Test - | s | 48 | — | — |
| mm, 850° C.) Average | IEC 60695-2-12 | | | | |
| Afterflame Time | | | | | |
| Glow Wire Test 1.6 | Glow Wire Test - | ° C. | | | |
| mm, 960° C.) GWFI | IEC 60695-2-12 | | | | |
| Glow Wire Test (1.6 | Glow Wire Test - | s | | | |
| mm, 960° C.) Average | IEC 60695-2-12 | | | | |
| Afterflame Time | | | | | |
| 20 mm Vertical Burn, | Vertical Burn(20 | | V-0 | V-1 | NR |
| 3.2 mm | mm)-UL94 | | | | |
| 20 mm Vertical Burn, | Vertical Burn(20 | | V-2 | NR | NR |
| 1.6 mm | mm)-UL94 | | | | |
| 20 mm Vertical Burn, | Vertical Burn(20 | s | 39 | — | — |
| 1.6 mm Cummulative | mm)-UL94 | | | | |
| Afterflame Time | | | | | |
| 20 mm Vertical Burn, | Vertical Burn(20 | | | | |
| 0.8 mm | mm)-UL94 | | | | |
| 20 mm Vertical Burn, | Vertical Burn(20 | s | | | |
| 0.8 mm Cummulative | mm)-UL94 | | | | |
| Afterflame Time | | | | | |

TABLE 15
Test Results

| | | | Example | Comparative | Comparative | Comparative |
|---|---|---|---|---|---|---|
| Test | Method | Units | 4 | Example 9 | Example 10 | Example 11 |
| Tensile Strength @ | Tensile - ASTM | psi | 591 | 352 | 359 | 334 |
| Yield, Perpendicular | D412 | | | | | |
| Tensile Elongation @ | Tensile - ASTM | % | 687 | 440 | 432 | 434 |
| Break, Perpendicular | D412 | | | | | |
| Tensile Strength @ | Tensile - ASTM | psi | 353 | 389 | 394 | 378 |
| Yield, Parallel | D412 | | | | | |
| Tensile Elongation @ | Tensile - ASTM | % | 328 | 226 | 188 | 248 |
| Break, Parallel | D412 | | | | | |
| Hardness, Shore A, | Durometer | | 65 | 64 | 65 | 64 |
| Instantaneous | Hardness - (Shore | | | | | |
| | A) ASTM D2240 | | | | | |
| Hardness, Shore A | Durometer | | 58 | 57 | 59 | 57 |
| (delay) (10 s) | Hardness - (Shore | | | | | |
| | A) ASTM D2240 | | | | | |
| Glow Wire Test (1.6 | Glow Wire Test - | ° C. | pass | | | |
| mm, 850° C.) | IEC 60695-2-12 | | | | | |
| Glow Wire Test (1.6 | Glow Wire Test - | s | 34 | | | |
| mm, 850° C.) Average | IEC 60695-2-12 | | | | | |
| Afterflame Time | | | | | | |
| Glow Wire Test 1.6 | Glow Wire Test - | ° C. | | pass | pass | pass |
| mm, 960° C.) GWFI | IEC 60695-2-12 | | | | | |
| Glow Wire Test (1.6 | Glow Wire Test - | s | | 30 | 46 | 52 |
| mm, 960° C.) Average | IEC 60695-2-12 | | | | | |
| Afterflame Time | | | | | | |
| 20 mm Vertical Burn, | Vertical Burn(20 | | V-0 | | | |
| 3.2 mm | mm)-UL94 | | | | | |
| 20 mm Vertical Burn, | Vertical Burn(20 | | V-0 | V-0 | V-0 | V-2 |
| 1.6 mm | mm)-UL94 | | | | | |
| 20 mm Vertical Burn, | Vertical Burn(20 | s | 5 | 2 | 26 | 27 |
| 1.6 mm Cummulative | mm)-UL94 | | | | | |
| Afterflame Time | | | | | | |
| 20 mm Vertical Burn, | Vertical Burn(20 | | | V-2 | NR | |
| 0.8 mm | mm)-UL94 | | | | | |
| 20 mm Vertical Burn, | Vertical Burn(20 | s | | 41 | 24 | |
| 0.8 mm Cummulative | mm)-UL94 | | | | | |
| Afterflame Time | | | | | | |

TABLE 16
Test Results

| | | | Comparative | Comparative | Comparative | Comparative |
|---|---|---|---|---|---|---|
| Test | Method | Units | Example 12 | Example 13 | Example 14 | Example 15 |
| Tensile Strength @ | Tensile - ASTM | psi | 336 | 350 | 387 | 345 |
| Yield, Perpendicular | D412 | | | | | |
| Tensile Elongation | Tensile - ASTM | % | 467 | 453 | 448 | 492 |
| @ Break, | D412 | | | | | |
| Perpendicular | | | | | | |
| Tensile Strength @ | Tensile - ASTM | psi | 376 | 371 | 409 | 385 |
| Yield, Parallel | D412 | | | | | |
| Tensile Elongation | Tensile - ASTM | % | 284 | 247 | 290 | 276 |
| @ Break, Parallel | D412 | | | | | |
| Hardness, Shore A, | Durometer | | 64 | 65 | 67 | 64 |
| Instantaneous | Hardness - (Shore | | | | | |
| | A) ASTM D2240 | | | | | |
| Hardness, Shore A | Durometer | | 57 | 58 | 61 | 57 |
| (delay) (10 s) | Hardness - (Shore | | | | | |
| | A) ASTM D2240 | | | | | |
| Glow Wire Test (1.6 | Glow Wire Test - | ° C. | | | | |
| mm, 850° C.) | IEC 60695-2-12 | | | | | |
| Glow Wire Test (1.6 | Glow Wire Test - | S | | | | |
| mm, 850° C.) | IEC 60695-2-12 | | | | | |
| Average Afterflame | | | | | | |
| Time | | | | | | |
| Glow Wire Test 1.6 | Glow Wire Test - | | fail | pass | pass | fail |
| mm, 960° C.) GWFI | IEC 60695-2-12 | | | | | |
| Glow Wire Test (1.6 | Glow Wire Test - | S | 176 | 40 | 55 | 155 |
| mm, 960° C.) | IEC 60695-2-12 | | | | | |
| Average Afterflame | | | | | | |
| Time | | | | | | |
| 20 mm Vertical | Vertical Burn(20 | | | | | |
| Burn, 3.2 mm | mm)-UL94 | | | | | |
| 20 mm Vertical | Vertical Burn(20 | | NR | NR | V-0 | V-2 |
| Burn, 1.6 mm | mm)-UL94 | | | | | |
| 20 mm Vertical | Vertical Burn(20 | S | 94 | 64 | 15 | 68 |
| Burn, 1.6 mm | mm)-UL94 | | | | | |
| Cummulative | | | | | | |
| Afterflame Time | | | | | | |
| 20 mm Vertical | Vertical Burn(20 | | | | NR | |
| Burn, 0.8 mm | mm)-UL94 | | | | | |
| 20 mm Vertical | Vertical Burn(20 | S | | | 36 | |
| Burn, 0.8 mm | mm)-UL94 | | | | | |
| Cummulative | | | | | | |
| Afterflame Time | | | | | | |

TABLE 17
Test Results

| | | | Comparative | Comparative | Comparative | Comparative |
|---|---|---|---|---|---|---|
| Test | Method | Units | Example 16 | Example 17 | Example 18 | Example 19 |
| Tensile Strength @ | Tensile - ASTM | psi | 358 | 338 | 310 | 320 |
| Yield, Perpendicular | D412 | | | | | |
| Tensile Elongation | Tensile - ASTM | % | 498 | 419 | 544 | 454 |
| @ Break, | D412 | | | | | |
| Perpendicular | | | | | | |
| Tensile Strength @ | Tensile - ASTM | psi | 421 | 445 | 361 | 397 |
| Yield, Parallel | D412 | | | | | |
| Tensile Elongation | Tensile - ASTM | % | 295 | 275 | 266 | 264 |
| @ Break, Parallel | D412 | | | | | |
| Hardness, Shore A, | Durometer | | 66 | 66 | 61 | 65 |
| Instantaneous | Hardness - (Shore | | | | | |
| | A) ASTM D2240 | | | | | |
| Hardness, Shore A | Durometer | | 59 | 60 | 54 | 58 |
| (delay) (10 s) | Hardness - (Shore | | | | | |
| | A) ASTM D2240 | | | | | |
| Glow Wire Test (1.6 | Glow Wire Test - | ° C. | | | | |
| mm, 850° C.) | IEC 60695-2-12 | | | | | |
| Glow Wire Test (1.6 | Glow Wire Test - | S | | | | |
| mm, 850° C.) | IEC 60695-2-12 | | | | | |
| Average Afterflame | | | | | | |
| Time | | | | | | |
| Glow Wire Test 1.6 | Glow Wire Test - | O | pass | pass | fail | pass |
| mm, 960° C.) GWFI | IEC 60695-2-12 | | | | | |
| Glow Wire Test (1.6 | Glow Wire Test - | S | 44 | 40 | 179 | 40 |
| mm, 960° C.) | IEC 60695-2-12 | | | | | |
| Average Afterflame | | | | | | |
| Time | | | | | | |
| 20 mm Vertical | Vertical Burn(20 | | | | | |
| Burn, 3.2 mm | mm)-UL94 | | | | | |
| 20 mm Vertical | Vertical Burn(20 | | V-0 | V-0 | V-2 | V-0 |
| Burn, 1.6 mm | mm)-UL94 | | | | | |
| 20 mm Vertical | Vertical Burn(20 | S | 13 | 2 | 76 | 12 |
| Burn, 1.6 mm | mm)-UL94 | | | | | |
| Cummulative | | | | | | |
| Afterflame Time | | | | | | |
| 20 mm Vertical | Vertical Burn(20 | | V-2 | V-2 | | V-2 |
| Burn, 0.8 mm | mm)-UL94 | | | | | |
| 20 mm Vertical | Vertical Burn(20 | S | 59 | 34 | | 28 |
| Burn, 0.8 mm | mm)-UL94 | | | | | |
| Cummulative | | | | | | |
| Afterflame Time | | | | | | |

TABLE 18
Test Results

| | | | Comparative | Comparative | Comparative |
|---|---|---|---|---|---|
| Test | Method | Units | Example 20 | Example 21 | Example 22 |
| Tensile Strength @ | Tensile - ASTM | psi | 317 | 355 | 336 |
| Yield, Perpendicular | D412 | | | | |
| Tensile Elongation @ | Tensile - ASTM | % | 468 | 528 | 495 |
| Break, Perpendicular | D412 | | | | |
| Tensile Strength @ | Tensile - ASTM | psi | 368 | 370 | 393 |
| Yield, Parallel | D412 | | | | |
| Tensile Elongation @ | Tensile - ASTM | % | 228 | 218 | 212 |
| Break, Parallel | D412 | | | | |
| Hardness, Shore A, | Durometer | | 63 | 65 | 64 |
| Instantaneous | Hardness - (Shore | | | | |
| | A) ASTM D2240 | | | | |
| Hardness, Shore A | Durometer | | 57 | 58 | 57 |
| (delay) (10 s) | Hardness - (Shore | | | | |
| | A) ASTM D2240 | | | | |
| Glow Wire Test (1.6 | Glow Wire Test - | ° C. | | | |
| mm, 850° C.) | IEC 60695-2-12 | | | | |
| Glow Wire Test (1.6 | Glow Wire Test - | s | | | |
| mm, 850° C.) Average | IEC 60695-2-12 | | | | |
| Afterflame Time | | | | | |
| Glow Wire Test 1.6 | Glow Wire Test - | ° C. | pass | fail | fail |
| mm, 960° C.) GWFI | IEC 60695-2-12 | | | | |
| Glow Wire Test (1.6 | Glow Wire Test - | s | 38 | 62 | 147 |
| mm, 960° C.) Average | IEC 60695-2-12 | | | | |
| Afterflame Time | | | | | |
| 20 mm Vertical Burn, | Vertical Burn(20 | | | | |
| 3.2 mm | mm)-UL94 | | | | |
| 20 mm Vertical Burn, | Vertical Burn(20 | | V-0 | V-2 | NR |
| 1.6 mm | mm)-UL94 | | | | |
| 20 mm Vertical Burn, | Vertical Burn(20 | s | 18 | 78 | 250 |
| 1.6 mm Cummulative | mm)-UL94 | | | | |
| Afterflame Time | | | | | |
| 20 mm Vertical Burn, | Vertical Burn(20 | | NR | | |
| 0.8 mm | mm)-UL94 | | | | |
| 20 mm Vertical Burn, | Vertical Burn(20 | s | 21 | | |
| 0.8 mm Cummulative | mm)-UL94 | | | | |
| Afterflame Time | | | | | |

TABLE 19
Test Results

| | | | Comparative | Comparative | Comparative |
|---|---|---|---|---|---|
| Test | Method | Units | Example 23 | Example 24 | Example 25 |
| Tensile Strength @ | Tensile - ASTM | psi | 331 | 495 | 474 |
| Yield, Perpendicular | D412 | | | | |
| Tensile Elongation @ | Tensile - ASTM | % | 522 | 722 | 658 |
| Break, Perpendicular | D412 | | | | |
| Tensile Strength @ | Tensile - ASTM | psi | 375 | 358 | 416 |
| Yield, Parallel | D412 | | | | |
| Tensile Elongation @ | Tensile - ASTM | % | 245 | 330 | 292 |
| Break, Parallel | D412 | | | | |
| Hardness, Shore A, | Durometer | | 64 | 63 | 65 |
| Instantaneous | Hardness - (Shore | | | | |
| | A) ASTM D2240 | | | | |
| Hardness, Shore A | Durometer | | 56 | 56 | 59 |
| (delay) (10 s) | Hardness - (Shore | | | | |
| | A) ASTM D2240 | | | | |
| Glow Wire Test (1.6 | Glow Wire Test - | ° C. | | | |
| mm, 850° C.) | IEC 60695-2-12 | | | | |
| Glow Wire Test (1.6 | Glow Wire Test - | s | | | |
| mm, 850° C.) Average | IEC 60695-2-12 | | | | |
| Afterflame Time | | | | | |
| Glow Wire Test 1.6 | Glow Wire Test - | ° C. | pass | pass | pass |
| mm, 960° C.) GWFI | IEC 60695-2-12 | | | | |
| Glow Wire Test (1.6 | Glow Wire Test - | s | 37 | 41 | 38 |
| mm, 960° C.) Average | IEC 60695-2-12 | | | | |
| Afterflame Time | | | | | |
| 20 mm Vertical Burn, | Vertical Burn(20 | | | | |
| 3.2 mm | mm)-UL94 | | | | |
| 20 mm Vertical Burn, | Vertical Burn(20 | | V-0 | V-0 | V-0 |
| 1.6 mm | mm)-UL94 | | | | |
| 20 mm Vertical Burn, | Vertical Burn(20 | s | 2 | 11 | 5 |
| 1.6 mm Cummulative | mm)-UL94 | | | | |
| Afterflame Time | | | | | |
| 20 mm Vertical Burn, | Vertical Burn(20 | | V-2 | V-2 | V-2 |
| 0.8 mm | mm)-UL94 | | | | |
| 20 mm Vertical Burn, | Vertical Burn(20 | s | 36 | 13 | 13 |
| 0.8 mm Cummulative | mm)-UL94 | | | | |
| Afterflame Time | | | | | |

TABLE 20
Test Results

| | | Example | Example | Example | Example | Example |
|---|---|---|---|---|---|---|
| Method | Units | 5 | 6 | 7 | 8 | 9 |
| Tensile - ASTM D412 | psi | 524 | 723 | 605 | 244 | 831 |
| Tensile - ASTM D412 | % | 1072 | 1098 | 947 | 1233 | 1087 |
| Tensile - ASTM D412 | psi | 520 | 560 | 568 | 153 | 741 |
| Tensile - ASTM D412 | % | 520 | 501 | 424 | 931 | 413 |
| Durometer Hardness - (Shore A) | | | | | | |
| ASTM D2240 | | | | | | |
| Durometer Hardness - (Shore A) | | 74.1 | 68.2 | 69.1 | 29.9 | 80.9 |
| ASTM D2240 | | | | | | |
| Glow Wire Test - IEC 60695-2-12 | ° C. | | | | | |
| Glow Wire Test - IEC 60695-2-12 | s | | | | | |
| Glow Wire Test - IEC 60695-2-12 | ° C. | pass | pass | pass | pass | pass |
| Glow Wire Test - IEC 60695-2-12 | s | 39 | 33 | 36 | 34 | 35 |
| Vertical Burn(20 mm)-UL94 | | | | | | |
| Vertical Burn(20 mm)-UL94 | | V-0 | V-0 | V-0 | V-0 | V-0 |
| Vertical Burn(20 mm)-UL94 | s | 15 | 4 | 21 | 18 | 5 |
| Vertical Burn(20 mm)-UL94 | | | | | | |
| Vertical Burn(20 mm)-UL94 | s | | | | | |

TABLE 21
Test Results

| | | Exam- | Exam- | Exam- | Exam- | Exam- |
|---|---|---|---|---|---|---|
| Method | Units | ple 10 | ple 11 | ple 12 | ple 13 | ple 14 |
| Tensile - ASTM D412 | psi | 400 | 725 | 770 | 518 | 815 |
| Tensile - ASTM D412 | % | 1048 | 1075 | 942 | 920 | 923 |
| Tensile - ASTM D412 | psi | 365 | 521 | 745 | 524 | 751 |
| Tensile - ASTM D412 | % | 467 | 492 | 419 | 518 | 442 |
| Durometer Hardness - (Shore A) | | | | | | |
| ASTM D2240 | | | | | | |
| Durometer Hardness - (Shore A) | | 55.9 | 68.4 | 80.9 | 75.1 | 80.1 |
| ASTM D2240 | | | | | | |
| Glow Wire Test - IEC 60695-2-12 | ° C. | | | | | |
| Glow Wire Test - IEC 60695-2-12 | s | | | | | |
| Glow Wire Test - IEC 60695-2-12 | ° C. | pass | pass | pass | pass | pass |
| Glow Wire Test - IEC 60695-2-12 | s | 40 | 32 | 36 | 39 | 32 |
| Vertical Burn(20 mm)-UL94 | | | | | | |
| Vertical Burn(20 mm)-UL94 | | V-0 | V-0 | V-0 | V-0 | V-0 |
| Vertical Burn(20 mm)-UL94 | s | 16 | 14 | 8 | 5 | 15 |
| Vertical Burn(20 mm)-UL94 | | | | | | |
| Vertical Burn(20 mm)-UL94 | s | | | | | |

TABLE 22
Test Results

| | | Example | Example | Example | Example | Example | Example |
|---|---|---|---|---|---|---|---|
| Method | Units | 15 | 16 | 17 | 18 | 19 | 20 |
| Tensile - ASTM D412 | psi | 389 | 1128 | 27 | 348 | 571 | 575 |
| Tensile - ASTM D412 | % | 889 | 958 | 1188 | 883 | 1089 | 927 |
| Tensile - ASTM D412 | psi | 348 | 1045 | 159 | 343 | 529 | 538 |
| Tensile - ASTM D412 | % | 533 | 434 | 954 | 497 | 490 | 456 |
| Durometer Hardness - (Shore A) | | | | | | | |
| ASTM D2240 | | | | | | | |
| Durometer Hardness - (Shore A) | | 54.9 | 86.9 | 30.2 | 56 | 72.2 | 70.2 |
| ASTM D2240 | | | | | | | |
| Glow Wire Test - IEC 60695-2-12 | ° C. | | | | | | |
| Glow Wire Test - IEC 60695-2-12 | s | | | | | | |
| Glow Wire Test - IEC 60695-2-12 | ° C. | pass | pass | pass | pass | pass | pass |
| Glow Wire Test - IEC 60695-2-12 | s | 32 | 31 | 41 | 31 | 37 | 32 |
| Vertical Burn(20 mm)-UL94 | | | | | | | |
| Vertical Burn(20 mm)-UL94 | | V-0 | V-0 | V-0 | V-0 | V-0 | V-0 |
| Vertical Burn(20 mm)-UL94 | s | 31 | 17 | 35 | 26 | 15 | 15 |
| Vertical Burn(20 mm)-UL94 | | | | | | | |
| Vertical Burn(20 mm)-UL94 | s | | | | | | |

Without undue experimentation, those having ordinary skill in the art can utilize the written description, including the Examples, to make and use aspects of the disclosed invention.

All documents cited in the Embodiments of the Invention are incorporated herein by reference in their entirety unless otherwise specified. The citation of any document is not to be construed as an admission that it is prior art with respect to the disclosed invention.

While particular embodiments of the disclosed invention have been illustrated and described, it would be obvious to those skilled in the art that various other changes and modifications can be made without departing from the spirit and scope of the invention. The appended claims are intended to cover all such changes and modifications within the scope of the disclosed invention.

What is claimed is:

1. A flame retardant polymer composition, comprising:
a) up to about 20 wt. % polypropylene, based on total weight of the composition;
b) a thermoplastic elastomer;
c) an oil; and
d) a flame retardant system;
wherein the flame retardant system comprises ammonium polyphosphate, a phosphinate salt, and a oligomer or polymer of a 1,3,5-triazine derivative.

2. The flame retardant polymer composition of claim 1, wherein the oligomer or polymer of a 1,3,5-triazine derivative
includes an aliphatic or an aromatic heterocyclic compound comprising at least one heteroatom covalently bonded to a triazine ring through the heteroatom, and
a linking group selected from a linear or cyclic primary or secondary diamine compound.

3. The flame retardant polymer composition of claim 1, wherein the ammonium polyphosphate is crystalline form II.

4. The flame retardant polymer composition of claim 1, wherein the phosphinate salt includes
Mg, Ca, Al, Sb, Sn, Ge, Zn, Mo, Ti, Fe, Zr, Ce, Bi, Sr, Mn, Li, Na, K, or a protonated nitrogen base.

5. The flame retardant polymer composition of claim 1, wherein
the ammonium polyphosphate comprises about 15 to about 28.5 wt. %, based on total weight of the polymer composition;
the phosphinate salt comprises about 4 to about 15 wt. %, based on total weight of the polymer composition; and
the oligomer or polymer of a 1,3,5-triazine derivative comprises about 2.5 to about 15 wt. %, based on total weight of the polymer composition.

6. The flame retardant polymer composition of claim 1, wherein the ammonium polyphosphate comprises about 19.5 to about 27 wt. %, based on total weight of the polymer composition; the oligomer or polymer of a 1,3,5-triazine derivative comprises about 5.5 to about 11.5 wt. %, based on total weight of the polymer composition; and the triazine-based copolymer comprises about 4 to about 12.5 wt. %, based on total weight of the polymer composition.

7. The flame retardant polymer composition of claim 1, wherein the ammonium polyphosphate comprises about 20.5 to about 25.5 wt. %, based on total weight of the polymer composition; the phosphinate salt comprises about 6 to about 10 wt. %, based on total weight of the polymer composition; and the oligomer or polymer of a 1,3,5-triazine derivative comprises about 6 to about 10 wt. %, based on total weight of the polymer composition.

8. The flame retardant polymer composition of claim 1, comprising from about 10 to about 40 wt. % thermoplastic elastomer, based on total weight of the composition.

9. The flame retardant polymer composition of claim 1, comprising greater than 0 to about 40 wt. % oil, based on total weight of the composition.

10. The flame retardant polymer composition of claim 1, comprising from about 10 to about 70 wt. % flame retardant system, based on total weight of the composition.

11. The flame retardant polymer composition of claim 1, wherein the thermoplastic elastomer is selected from the group consisting of styrenic block copolymers, thermoplastic polyolefins, propylene/α-olefin copolymers, ethylene/α-olefin copolymers, copolyesters, thermoplastic polyurethanes, copolyamides, olefin block copolymers, low density polyethylenes, high density polyethylenes, and combinations thereof.

12. The flame retardant polymer composition of claim 1, further comprising from about 0 to about 5 wt. % of at least one additive, based on the total weight of the compound, wherein the additive selected from the group consisting of adhesion promoters; biocides; anti-fogging agents; anti-static agents; anti-oxidants; bonding, blowing and foaming agents; dispersants; fillers and extenders; smoke suppressants; impact modifiers; initiators; lubricants; micas; pigments, colorants and dyes; processing aids; release agents; silanes, titanates and zirconates; slip agents, anti-blocking agents; stabilizers; stearates; ultraviolet light absorbers; viscosity regulators; waxes; catalyst deactivators, and combinations of two or more thereof.

13. A molded article made from the flame retardant polymer composition of claim 1.

14. An extruded article made from the flame retardant polymer composition of claim 1.

15. A calendared article made from the flame retardant polymer composition of claim 1.

16. A thermoformed article made from the flame retardant polymer composition of claim 1.

17. A method of using the flame retardant polymer composition of claim 1, comprising the step of shaping the compound into an article designed to resist combustion or molten dripping in the presence of flame.

18. The method of claim 17, wherein the shaping comprises extruding, molding, calendaring, or thermoforming.
